(19) United States
(12) Patent Application Publication
(10) Pub. No.: US 2009/0071681 A1
(43) Pub. Date: Mar. 19, 2009

(54) MODULAR ELECTRICAL ASSEMBLY

(75) Inventor: Huang JUNJIE, Fujian (CN)

Correspondence Address: PILLSBURY WINTHROP SHAW PITTMAN, LLP, P.O. BOX 10500, MCLEAN, VA, 22102, US

(73) Assignee: FUZHOU JJ INDUSTRIES, INC., Fuzhou (CN)

(21) Appl. No.: 12/189,363

(22) Filed: Aug. 11, 2008

Related U.S. Application Data
(60) Provisional application No. 60/972,083, filed on Sep. 13, 2007.

(51) Int. Cl. H02G 3/14

(52) U.S. Cl. 174/66

(57) ABSTRACT

A weatherproof, modular, outdoor electrical assembly for electrical devices includes a base, an adapter plate configured to fit into the opening of the base, and a cover. The electrical assembly further includes one or more adapter inserts that are attached to the adapter plate to convert the adapter plate to accommodate at least one electrical device. The assembly also includes a removable bolt to form a hinge on a vertical or horizontal side between the base and the cover. The assembly further includes a removable drain plate and flexible members to prevent water from entering the assembly.

### CROSS REFERENCE TO RELATED APPLICATIONS

This application claims priority to U.S. provisional application Ser. No. 60/972,083, filed Sep. 13, 2007, the entire contents of which is incorporated herein by reference.

### FIELD OF THE INVENTION

The present invention relates to a modular electrical assembly for electrical devices.

### BACKGROUND OF THE INVENTION

Electrical devices used in conjunction with electrical device boxes vary and include electrical outlets (both standard and ground fault current interrupts), light switches (both toggle and rocker plates), rounds, and cable television and/or telephone ports. Conventional covers for electrical device boxes are designed to try and prevent inadvertent access to the electrical conductive elements of electrical devices and to hide associated wiring. Each type of electrical device requires different dimensioned access openings in a cover to accommodate it. However, conventional covers usually are non-convertible in their design, and therefore, each electrical device requires a different type of conventional cover configured for it. Thus, to install or service electrical devices, an electrician must carry several types of conventional covers to each site, which are time consuming and inefficient to install.

### SUMMARY OF THE INVENTION

Provided herein is an electrical assembly that can include a base configured for accepting at least one electrical device, the base having a rear wall, a top wall, a bottom wall, a pair of side walls and an opening located in the rear wall and an adapter plate comprising a front face and a rear face; the adapter plate is configured to (i) fit in the opening of the base and (ii) accept the at least one electrical device.

In one or more aspects the assembly can include a weatherproof cover, wherein the cover is secured to the base and is configured for covering the base, the adapter plate and the at least one electrical device so as to provide protection from the environment, the cover having a front wall, a top wall, a bottom wall and a pair of side walls.

In one or more aspects the assembly can include one or more adapter inserts placeable in an opening of the adapter plate, wherein the adapter inserts, upon assembly, allows the adapter plate to accommodate the at least one electrical device.

In one or more aspects the adapter inserts securely connect the adapter inserts with each other and with the adapter plate.

In one or more aspects the adapter insert comprises one or more tabs and one or more lips; each tab having a protrusion and each lip having a protrusion that mates with the tabs.

In one or more aspects the tabs are located on the outer periphery of the adapter insert and the lips are located on the inner periphery of the adapter insert.

In one or more aspects the tab on the outer periphery of an inner adapter insert interlocks with the lip on an inner periphery of an outer adapter insert, to connect the adapter inserts to each other.

In one or more aspects the tab on the outer periphery of the outer adapter insert interlocks with a lip on an inner periphery of the adapter plate, to connect the outer adapter insert with the adapter plate. In one or more aspects the shape of the adapter inserts may be selected from the group consisting of circular rings, oval rings, rectangular inserts and square inserts.

In one or more aspects the adapter plate has at least one opening for accommodating a GFCI electrical device or has at least two openings for accommodating a duplex electrical device.

In one or more aspects the adapter plate is assembled to the base by an interlock.

In one or more aspects the assembly can include (a) the base inner periphery has a pair of underhanging edges separated by a base central edge disposed thereon; (b) the adapter plate outer periphery has a pair of overhanging edges separated by an adapter plate central edge disposed thereon; and (c) the underhanging edges of the base interlock with the overhanging edges of the adapter plate.

In one or more aspects the assembly further includes (a) one or more notches in the base; (b) one or more ribs in the adapter plate; (c) an axis of rotation defined longitudinally along the one or more ribs; and wherein the one or more ribs are configured to fit into the one or more notches and are secured as the adapter plate is rotated about the axis of rotation.

In one or more aspects one or more notches are shaped to form a path receive the ribs along two axes. In one or more aspects the path may right angled, in others the path may be curved.

In one or more aspects to snap fit the adapter plate to the base, the ribs of the adapter plate are inserted into the notches of the base, and the adapter plate either falls down due to gravity or is pressed to the base by swiveling the adapter plate into the path so as to secure the adapter plate and the base to each other.

In one or more aspects the base further comprises slots located on the base side walls and the base walls of the base to insert a drain plate and the drain plate prevents water or moisture entering the enclosure from the base side walls. In one or more aspects the drain plate is plastic.

In one or more aspects the drain plate is removable and is interchangeable between the slots located on the base side walls and the base walls of the base.

In one or more aspects the drain plate is removed from the slot on the base wall of the base and is placed in the slot on the base side wall when the cover is changed from a vertical mounting position to a horizontal mounting position or when the cover is changed from a horizontal mounting position to a vertical mounting position.

In one or more aspects the rubber flaps are secured along the periphery of the base or the cover to protect the assembly from environmental contamination.

In one or more aspects one or more drain holes are located on the base wall of the base or the cover to drain water, when the drain plate fails to prevent water or moisture from entering the enclosure.

In one or more aspects the a first pair of laterally aligned hinge members projecting up from the cover top wall and a second pair of laterally aligned hinge members projecting up the cover side wall, each hinge member further comprising a raised member with a bolt-receiving opening; a first pair of laterally aligned hinge members projecting up from the base top wall and a second pair of laterally aligned hinge members projecting up from the base side wall, each hinge member having a raised member and a bolt-receiving opening located in the raised member; a removable bolt to hingeably connect the cover to the base; the bolt can be slid through the bolt-receiving openings located in the raised members on the cover top wall and the base top wall or through the bolt-receiving openings located in the raised members on the cover side wall and the base side wall to secure the cover and the base in a vertical orientation or horizontal orientation respectively; wherein the bolt is removed from the bolt-receiving openings located in the raised members of the cover top wall and is placed in the bolt-receiving openings located in the raised members of the cover side wall, when the cover is changed from a vertical mounting position to a horizontal mounting position, and the bolt is moved from the bolt-receiving openings located in the raised members of the cover side wall and is placed in the bolt-receiving openings located in the raised members of the cover front wall, when the cover is changed from a horizontal mounting position to a vertical mounting position.

In one or more aspects the raised members of the hinge members are located on either side of the center of the top wall and the side walls of the cover and the base.

In one or more aspects the bolt-receiving openings located on the cover have threads located in the raised member and the bolt have threads.

In one or more aspects a latch tab located on the base bottom wall engages with a latch plate on the cover so as to secure the cover to the base together.

In one or more aspects a latch tab located on the base bottom wall of the base has a hook structure.

In one or more aspects one or more key holes are located on the rear wall of the base to mount the base on the electrical device.

In one or more aspects the adapter plate and/or the adapter insert has a spring tongue interlocking mechanism configured to provide a clamping force on an object configured to mate with the adapter insert.

In one or more aspects the adapter plate and/or adapter insert comprises a cantilevered member integral with the adapter plate configured to provide a clamping force on an object configured to mate with the adapter plate.

In one or more aspects the adapter insert includes a contoured surface configured to mate with the cantilevered member integral with the adapter plate.

In one or more aspects the base is provided with a side-wall opening, wherein the base includes a plurality of flexible members directly abutting each other and the plurality of flexible members fill the entire space formed by said opening.

Provided herein is a method of installing an outdoor electrical assembly having A) snap fitting an adapter plate into an opening of a base by 1) inserting one or more ribs of the adapter plate into one or more notches of the base; and 2) swiveling the adapter plate into the base and securing the adapter plate into place; and B) inserting one or more adapter inserts into an opening of the adapter plate by 1) interlocking one or more tabs on the outer periphery of an inner adapter insert with one or more lips on an inner periphery of an outer adapter insert, thereby connecting the adapter inserts to each other; and 2) interlocking one or more tabs on the outer periphery of the outer adapter with one or more lips on an inner periphery of the adapter plate, thereby connecting the adapter inserts to each other; and C) connecting the base and a cover in either a vertical mounting position or a horizontal mounting using a removable bolt; wherein changing the cover from a vertical mounting position to a horizontal mounting position includes 1) removing the bolt from a pair of laterally aligned hinge members located on the cover top wall and a pair of laterally aligned hinge members located on the base top wall; 2) aligning a pair of laterally aligned hinge members located on the cover side wall with a pair of laterally aligned hinge members located on the base side wall; and 3) sliding the bolt through bolt-receiving opening located on the cover side wall and the base side wall, thus connecting the base to the cover in a horizontal mounting position.

In one or more aspects the assembly comprises a pair of upward sloping edges located on either side of base central edge; and a pair of downward sloping edges located on either side of adapter plate central edge.

In one or more aspects the pair of upward sloping edges of the base engage with the pair of downward sloping edges of the adapter plate so as to secure the adapter plate in place with the base.

In one or more aspects the assembly comprises an inner water dam and an outer water dam located on the periphery of the base to collect water so as to prevent water from entering the electrical device.

Other objects, aspects, and advantages of the present invention will become apparent from the following description, the accompanying drawings, and the appended claims.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates a view of a base with an adapter plate fitted in a centrally located opening, in accordance with an aspect of the present invention;

FIG. 2 illustrates a view of the base with the centrally located opening, in accordance with an aspect of the present invention;

FIG. 3 illustrates a front and a rear view of the adapter plate, in accordance with an aspect of the present invention;

FIG. 4 illustrates a view of an adapter insert, in accordance with an aspect of the present invention;

FIG. 5 illustrates a view of an outer adapter insert assembled with the adapter plate, in accordance with an aspect of the present invention;

FIG. 6 illustrates a view of the outer adapter insert and an inner adapter insert assembled with the adapter plate, in accordance with an aspect of the present invention;

FIG. 7 illustrates a view of the adapter plate having two openings to accommodate the duplex electrical devices, in accordance with an aspect of the present invention;

FIG. 8 illustrates a view of the adapter plate having one opening to accommodate the GFCI electrical devices, in accordance with an aspect of the present invention;

FIG. 9 illustrates a view of the base having the adapter plate with the inner and the outer adapter inserts assembled to the adapter plate, in accordance with an aspect of the present invention;

FIG. 10 illustrates a view of the assembly with the base connected with the cover using a removable bolt, in accordance with an aspect of the present invention;

FIG. 11 illustrates another view of the assembly with the base connected with the cover using the removable bolt, in accordance with an aspect of the present invention;

FIG. 12 illustrates another view of the assembly with the base connected with the cover using the removable bolt, in accordance with an aspect of the present invention;

FIG. 13 illustrates a view of the assembly with adapter insert shown in the side entry position, in accordance with an aspect of the present invention;

FIG. 14 illustrates an exploded view of the base and the cover along with the bolt and hinges that connect them, in accordance with an aspect of the present invention;

FIG. 15 illustrates an exploded view of the base with drain holes, in accordance with an aspect of the present invention;

FIG. 16 illustrates an exploded view of the base with a water dam, in accordance with an aspect of the present invention;

FIG. 17 illustrates an exploded view of the base and the adapter plate assembly with underhanging edges, overhanging edges, upward sloping edges and downward sloping edges, in accordance with an aspect of the present invention;

FIG. 18 illustrates a perspective view of a base and a cover with an adapter plate fitted in a centrally located opening in the base, in accordance with an aspect of the present invention;

FIG. 19 illustrates a bottom view of a base having a cover and a centrally located opening with an adapter plate having two openings for a duplex electrical device;

FIG. 20 illustrates a rear view of an adapter plate having two openings for a duplex electrical device, wherein the adapter plate has a spring tongue interlocking mechanism;

FIG. 21 illustrates a front view of an adapter plate having two openings for a duplex electrical device, wherein the adapter plate has a spring tongue interlocking mechanism;

FIG. 22 illustrates a bottom view of a base having a cover and a centrally located opening with an adapter plate having a rectangular opening for a GFCI electrical device;

FIG. 23 illustrates a rear view of an adapter plate having an opening for a GFCI electrical device, wherein the adapter plate has a spring tongue interlocking mechanism;

FIG. 24 illustrates a front view of an adapter plate having an opening for a GFCI electrical device, wherein the adapter plate has a spring tongue interlocking mechanism;

FIG. 25 illustrates a bottom view of a base having a cover and a centrally located opening with an adapter plate having a circular opening for an electrical device;

FIG. 26 illustrates a rear view of an adapter plate having a circular opening for an electrical device, wherein the adapter plate has a spring tongue interlocking mechanism;

FIG. 27 illustrates a front view of an adapter plate having a circular opening for an electrical device, wherein the adapter plate has a spring tongue interlocking mechanism;

FIG. 28 illustrates a bottom view of a base having a cover and a centrally located opening with an adapter plate having a circular opening for an electrical device and an adapter insert configured to fit within the adapter plate;

FIG. 29 illustrates a rear view of an adapter plate having a circular opening for an electrical device and an adapter insert configured to fit within the adapter plate, wherein both the adapter plate and adapter insert have a spring tongue interlocking mechanism;

FIG. 30 illustrates a front view of an adapter plate having a circular opening for an electrical device and an adapter insert configured to fit within the adapter plate, wherein both the adapter plate and adapter insert have a spring tongue interlocking mechanism;

FIG. 31 illustrates a bottom view of a base having a cover and a centrally located opening with an adapter plate having a circular opening for an electrical device and an adapter insert configured to fit within the adapter plate;

FIG. 32 illustrates a rear view of an adapter plate having a circular opening for an electrical device and an adapter insert configured to fit within the adapter plate, wherein both the adapter plate and adapter insert have a spring tongue interlocking mechanism;

FIG. 33 illustrates a front view of an adapter plate having a circular opening for an electrical device and an adapter insert configured to fit within the adapter plate, wherein both the adapter plate and adapter insert have a spring tongue interlocking mechanism;

FIG. 34 illustrates a bottom view of a base having a cover and a centrally located opening with an adapter plate having a circular opening for an electrical device and an outer adapter insert configured to fit within the adapter plate and a inner adapter insert configured to fit within the outer adapter insert;

FIG. 35 illustrates a rear view of an adapter plate having a circular opening for an electrical device and an outer adapter insert configured to fit within the adapter plate and a inner adapter insert configured to fit within the outer adapter insert, wherein the adapter plate, outer adapter insert, and inner adapter insert all have a spring tongue interlocking mechanism;

FIG. 36 illustrates a front view of an adapter plate having a circular opening for an electrical device and an outer adapter insert configured to fit within the adapter plate and a inner adapter insert configured to fit within the outer adapter insert, wherein the adapter plate, outer adapter insert, and inner adapter insert all have a spring tongue interlocking mechanism;

FIG. 37 illustrates a bottom view of a base having a cover and a centrally located opening with an adapter plate having a circular opening and an outer adapter insert configured to fit within the adapter plate and a inner adapter insert configured to fit within the outer adapter insert;

FIG. 38 illustrates a rear view of an adapter plate having a circular opening and an outer adapter insert configured to fit within the adapter plate and a inner adapter insert configured to fit within the outer adapter insert, wherein the adapter plate, outer adapter insert, and inner adapter insert all have a spring tongue interlocking mechanism;

FIG. 39 illustrates a front view of an adapter plate having a circular opening and an outer adapter insert configured to fit within the adapter plate and a inner adapter insert configured to fit within the outer adapter insert, wherein the adapter plate, outer adapter insert, and inner adapter insert all have a spring tongue interlocking mechanism;

FIG. 40 illustrates an adapter plate having two openings for a duplex electrical device prior to insertion on the duplex electrical device, wherein the adapter plate has a spring tongue interlocking mechanism; and

FIG. 41 illustrates an adapter plate having two openings for a duplex electrical device inserted on the duplex electrical device, wherein the adapter plate has a spring tongue interlocking mechanism.

### DETAILED DESCRIPTION

While the invention has been shown and described with reference to a particular embodiment thereof, it will be understood to those skilled in the art, that various changes in form and details may be made therein without departing from the spirit and scope of the invention.

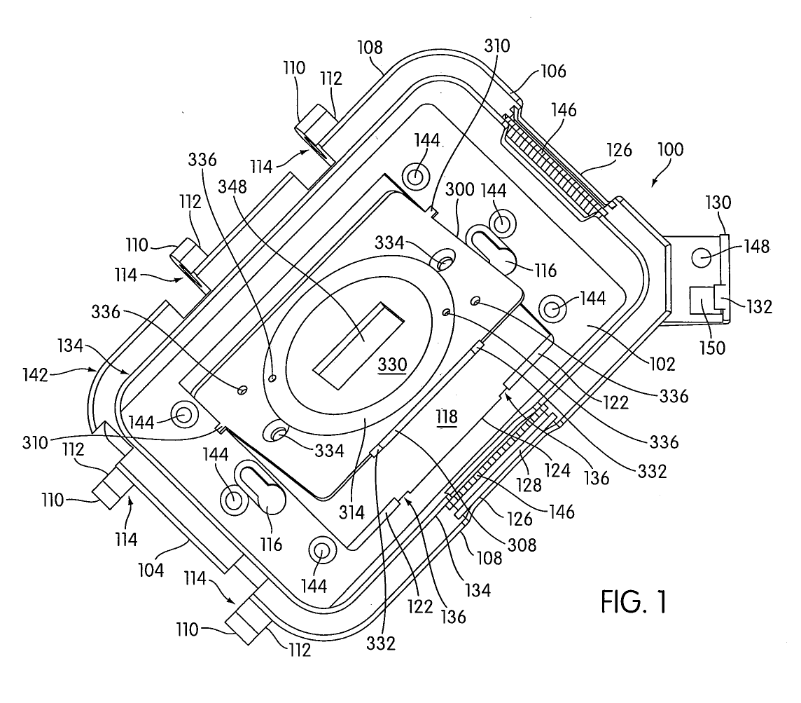

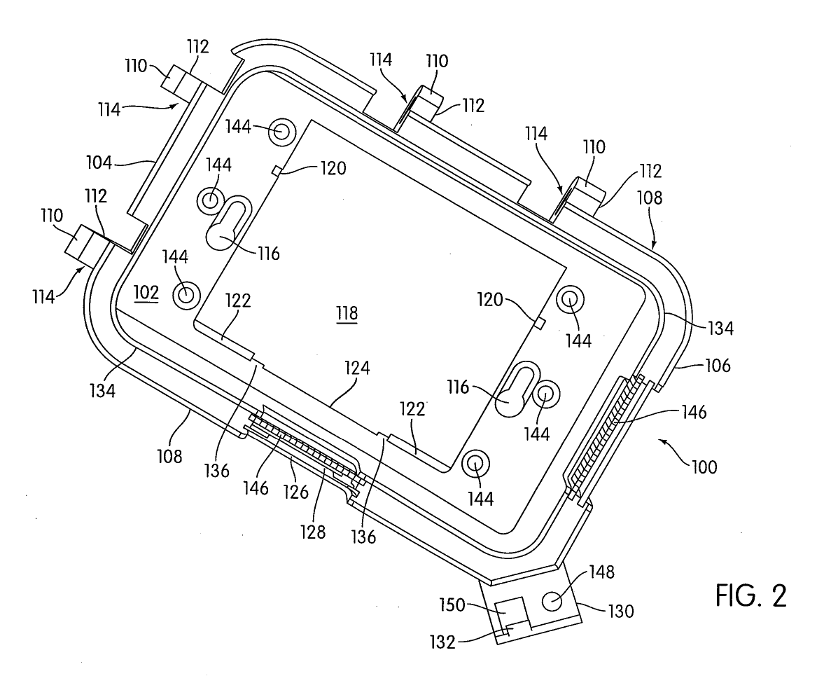

Referring to FIGS. 1 and 2 of the drawings, one aspect of the present invention includes an electrical assembly comprising a base 100 and an adapter plate 300, as would be apparent to one skilled in the art. The electrical assembly can be used for indoor and outdoor applications. The base 100 can be configured for accepting at least one electrical device. The adapter plate 300 can be configured to fit in the base 100 and to accept at least one electrical device. By way of non-limiting example, and as would be apparent to one skilled in the art, the electrical device may include, but not limited to a switch, an outlet, a receptacle, a ground fault circuit interrupter, and/or a dimmer.

The base 100 has a rear wall 102, a top wall 104, a bottom wall 106 and a pair of side walls 108. The base 100 has a pair of hinge members 110 located on the top wall 104 and a pair of hinge members 110 located on the side wall 108. The hinge members 110 may include raised members 112 respectively. The raised members 112 are provided with bolt-receiving openings 114 respectively. For example, in one embodiment, the bolt-receiving openings may be elliptical in shape. By way a of a non-limiting example, the bolt-receiving openings may have a recessed area that accommodates the bolt head to provide an aesthetically pleasing assembly.

The base 100 further comprises key holes 116 located on the rear wall 102 to secure the base 100 to an electrical device. The base 100 has an opening 118 located in the rear wall 102. The base 100 has one or more notches 120 located on the inner periphery of the rear wall 102. The base 100 has a pair of underhanging edges 122 separated by an edge 124 located on the inner periphery of the base rear wall 102.

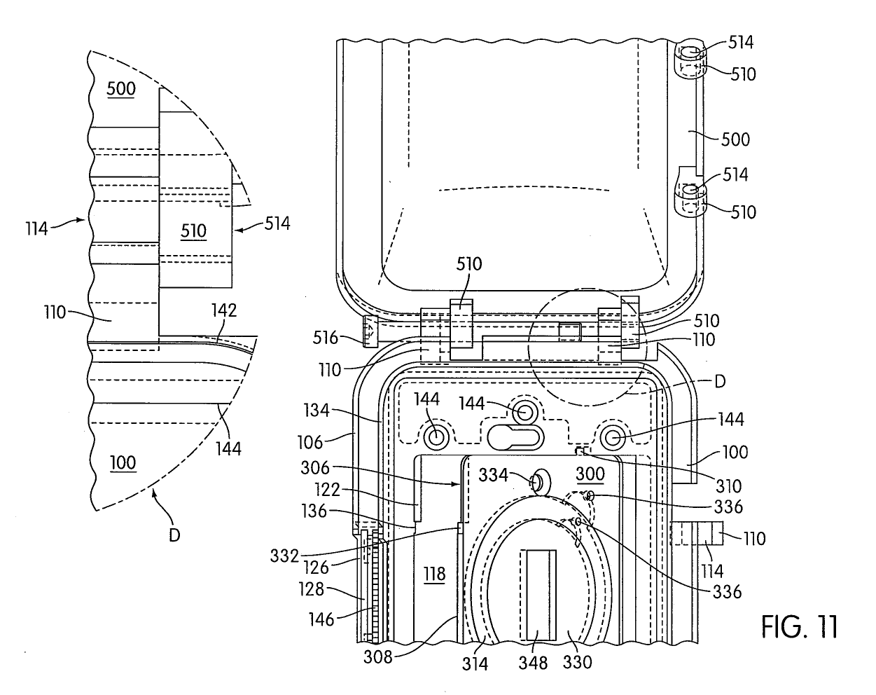

The base 100 has slots 126 located on the bottom wall 106 and the side wall 108. A drain plate 128 can be configured to be inserted into slots 126, to prevent water from entering the enclosure from the base side walls 108. The drain plate 128 can be made of any suitable material, for example, a plastic material. The drain plate 128 can be removable and interchangeable between the slots 126 located on the bottom wall 106 and the slots 126 located on the side wall 108. When the cover 500 (shown in FIG. 11) is changed from a vertical mounting position to a horizontal mounting position, the drain plate 128 is removed from slot 126 on the side wall 108 and is placed in the slot 126 located on the base wall 106. When the cover 500 is changed from a horizontal mounting position to a vertical mounting position, the drain plate 128 is removed from slot 126 on the base wall 106 and is placed in the slot 126 located on the base wall 108. Therefore, whether the assembly is in horizontal mounting position or in vertical mounting position, the drain plate 128 is always placed in the slot of the side wall of the base to prevent water from entering the enclosure from the side wall 108.

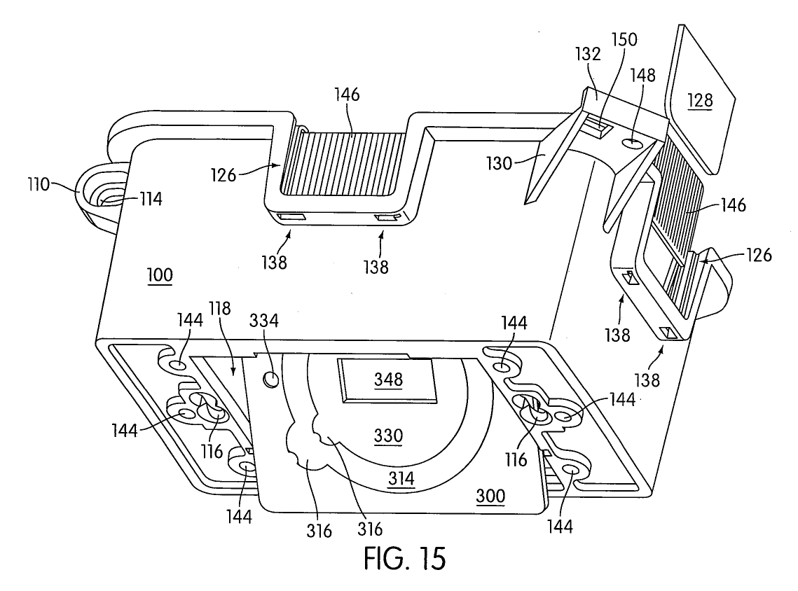

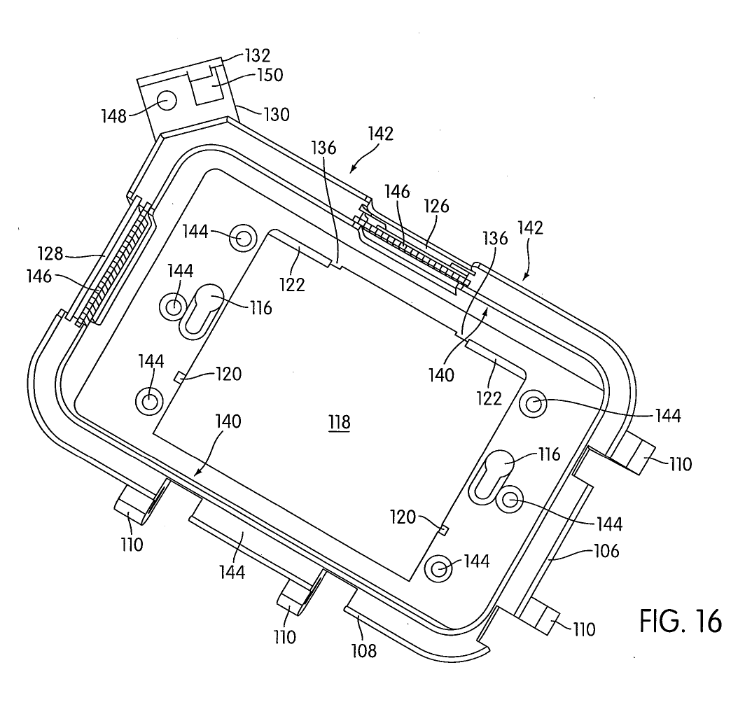

A latch tab 130 can be formed on the corner of the bottom wall 106 of the base 100. The latch tab 130 may have a unshaped member 132 located on it. Rubber flaps 134 can be secured along the periphery of the base 100 to prevent environmental contamination such as insect or debris accumulation, dust or dirt or rain water accumulation, or any other criteria as would be apparent to one of ordinary skill in the art. The base 100 includes upward sloping edges 136 located on either side of edge 124. FIG. 15 shows the base 100 with a pair of drain holes 138. The pair of drain holes 138 can be located on the walls of the base 100 to drain water, when the drain plate 128 fails to prevent water from entering the enclosure. As shown in FIG. 16, the base 100 includes an inner water dam 140 and an outer water dam 142. The inner water dam 140 and outer dam 142 are located along the periphery of the base 100 to collect the water. The water dam construction will prevent the water from entering the electrical device.

Base 100 is provided with holes 144 to receive screws or bolts in order to attach base 100 to a surface, such as a wall. A plurality of flexible parallel members 146 is provided in each opening 126 in order to form a barrier between the interior of base 100 and the exterior environment. An electrical cord may extend through opening 126 and force members 146 to deform around the cord, thereby allowing the cord to extend through base 100 and still have members 146 functioning as a barrier to the exterior environment. A hole 148 is provided in latch tab 130 in order to receive a lock.

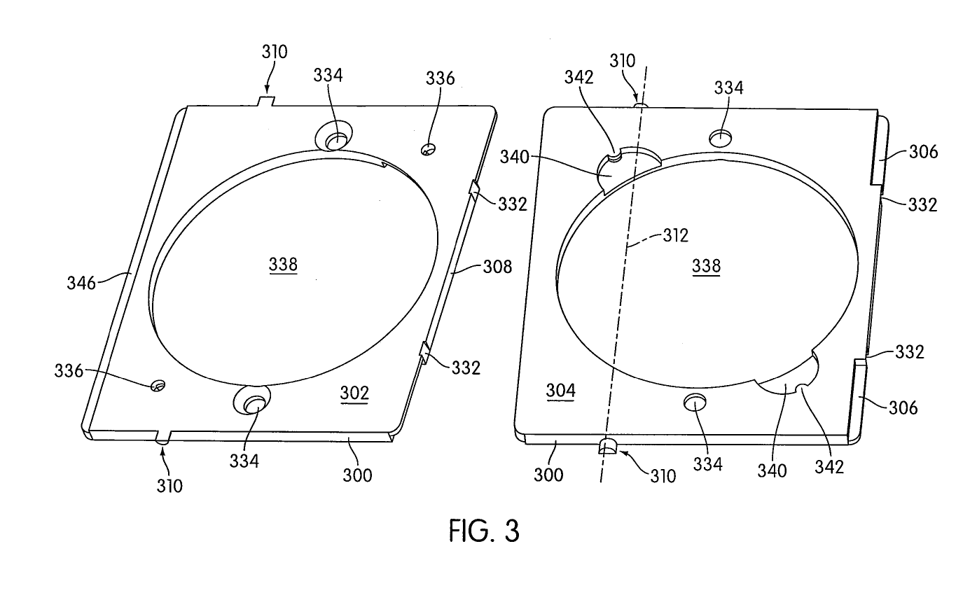

Referring to FIGS. 1-6, the adapter plate 300 comprises a front face 302 and a rear face 304. The adapter plate 300 can be configured to fit in the opening 118 of the base 100 and to accept at least one electrical device. A pair of overhanging edges 306 and 306 separated by an edge 308 are located on the outer periphery of the adapter plate 300. The adapter plate further comprises one or more ribs 310 located on the outer periphery of the adapter plate 300. An axis of rotation 312 is defined longitudinally along one or more ribs 310 of the adapter plate 300.

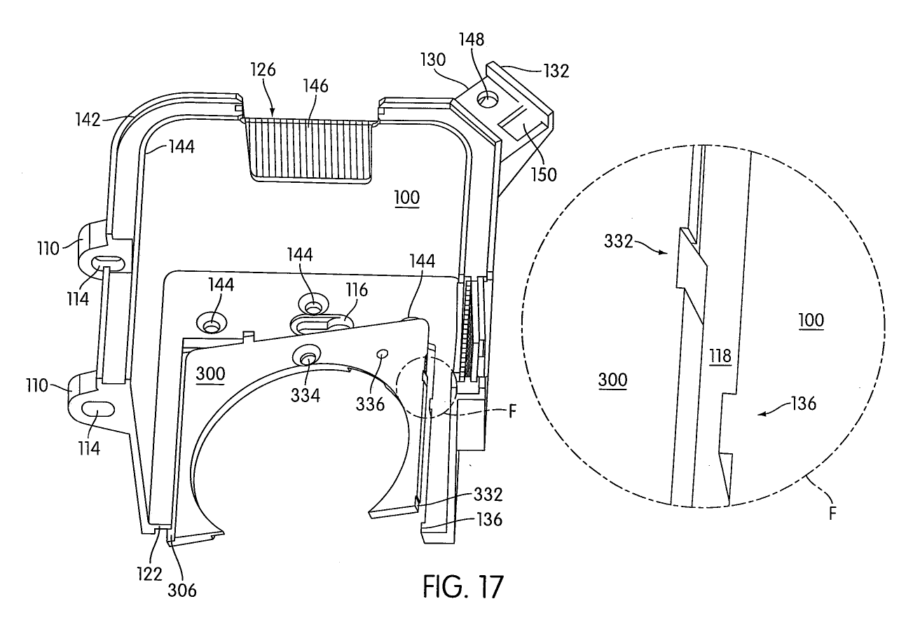

The ribs 310 of the adapter plate 300 can be configured to fit into the notches 120 of the base 100 and can be secured as the adapter plate 300 is rotated about the axis of rotation 312. The adapter plate 300 can be assembled to the base 100 by an interlock. The underhanging edges 122 and 122 of the base 100 interlocks with the overhanging edges 306 and 306 of the adapter plate 300. Thus, to snap fit the adapter plate 300 to the base 100, the ribs 310 are inserted into the notches 120. The adapter plate 300 either falls down due to gravity or can be pressed to the base 100 and the interlock is engaged. The adapter plate 300 can be pressed to the base 100 by swiveling the adapter plate into the base 100. The edge 124 of the base 100 and the edge 308 of the adapter plate 300 will secure the adapter plate 300 in place during the swiveling operation. The adapter plate 300 includes upward sloping edges 332 and 332 located on either side of the edge 308. When snap fitting the adapter plate 300 to the base 100, the upward sloping edges 332 and 332 of the adapter plate 300 engages with the downward sloping edges 136 and 136 of base 100 securing the adapter plate 300 in place during the assembly. FIG. 17 shows an enlarged view of the adapter plate 300 and the base 100 assembly with the upward sloping edges 332 and the downward sloping edges 136.

Alternatively, the base 100 may have a pair of overhanging edges separated by an edge that engages with a pair of underhanging edges separated by an edge located on the adapter plate 300.

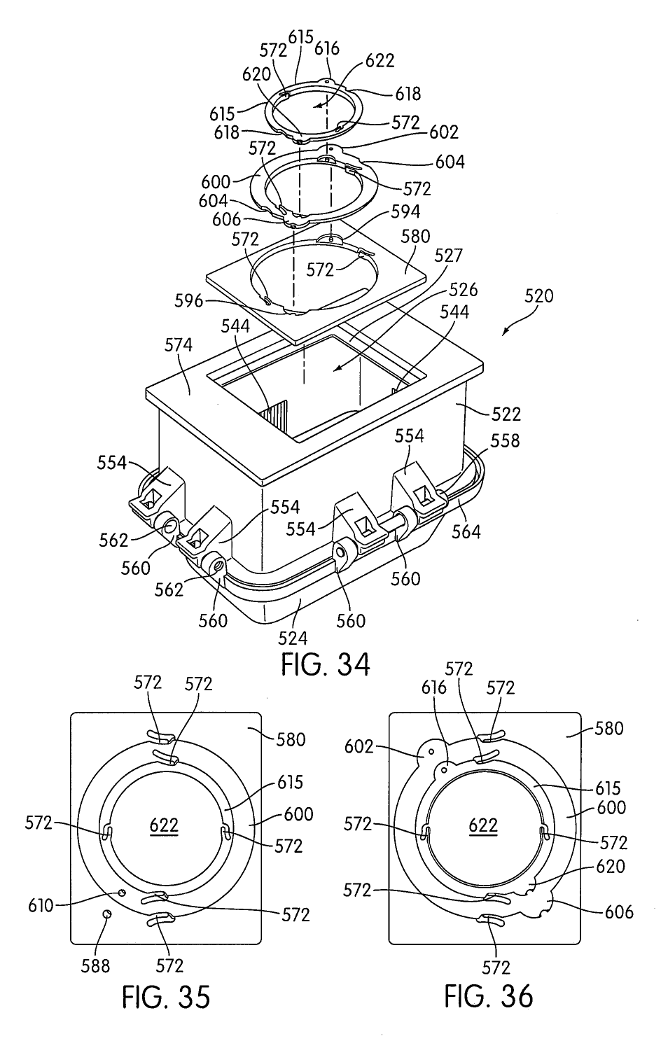

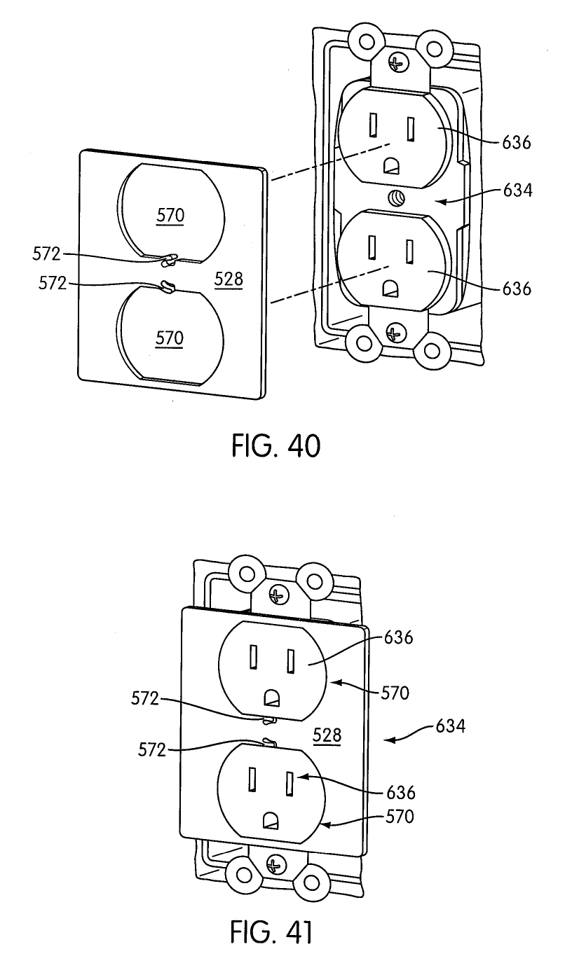

The adapter plate 300 includes holes 334 for receiving screws used to attach plate 300 to an electrical device 634 as shown in FIG. 40. Adapter plate 300 further includes holes 336 for receiving adapter plate 314 or 600 as shown in FIG. 34. An opening 338 is formed in plate 300 to receive an electrical outlet. Recesses surfaces 340 are formed in plate 300 along with tabs 342, both of which are configured to mate with portions 316 formed in adapter insert 314. A ledge 346 is formed on one side of plate 300.

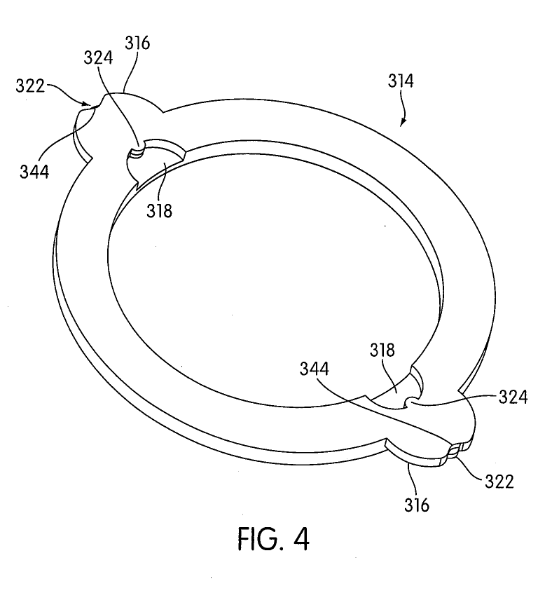

As best seen in FIG. 4, an adapter insert 314 securely connects the adapter inserts with each other and with the adapter plate. The adapter insert 314 comprises one or more tabs 316 and one or more lips 318. Each tab 316 has protrusion 322 and each lip 318 has a protrusion 324 located centrally that mates with the tabs 316. Adapter insert 314 includes surface surfaces 344 for mating with tabs 342 formed in recesses 340.

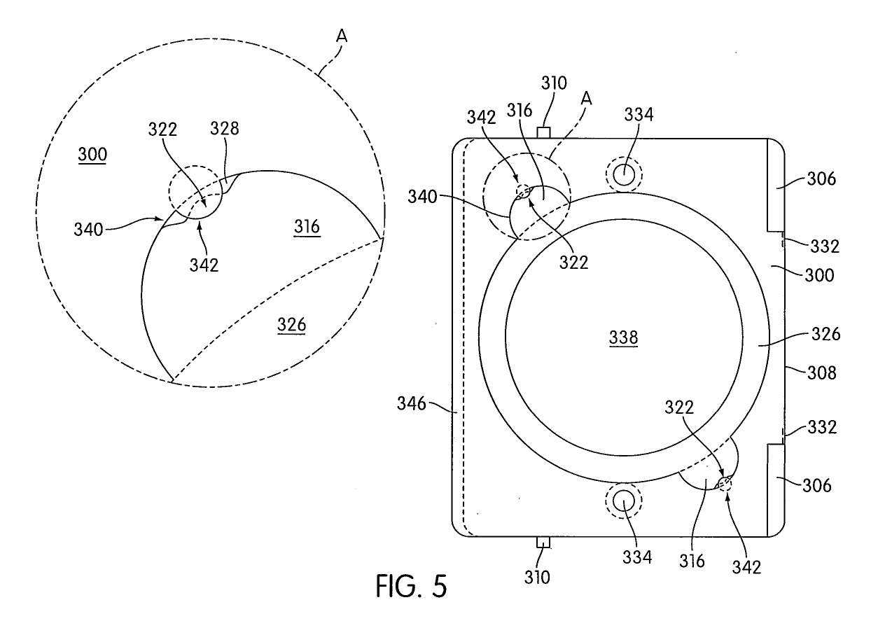

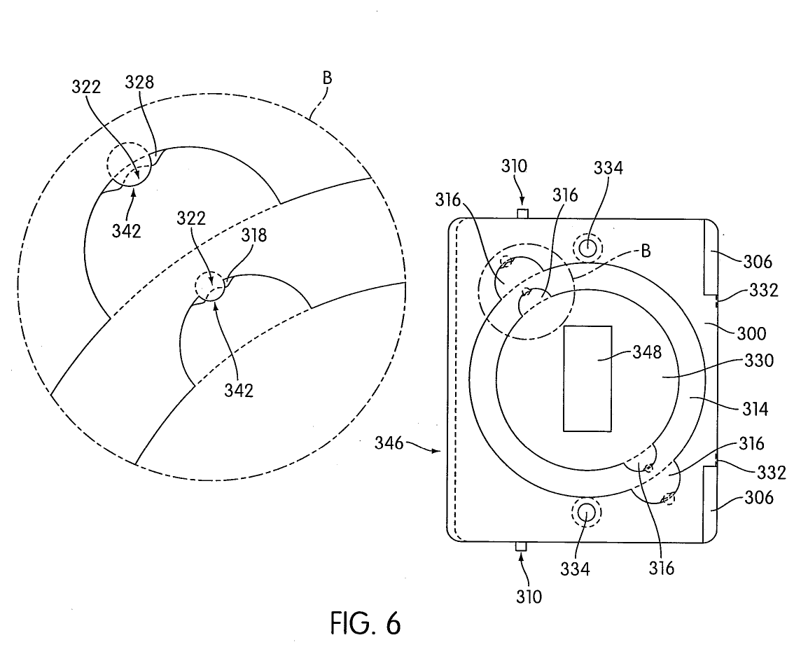

Referring to FIG. 5, the tabs 316 on the outer periphery of the outer adapter insert 326 interlocks with a lip 328 on an inner periphery of the adapter plate 300. An enlarged portion A is shown at right of plate 300 to illustrate the mating of portion 316 to recess 340 formed in plate 300. As shown in FIG. 6, the tabs 316 located on the outer periphery of an inner adapter insert 330 having an opening 348 interlocks with the lip 318 on the outer periphery of an outer adapter insert 326, to connect adapter inserts 326 and 330 to each other. A ledge 346 is formed on one side of plate 300. Alternatively, one or more tabs 316 may be located on the inner periphery of the adapter insert 314 and one or more lips 318 maybe located on the outer periphery of the adapter insert 314. The tabs and lips may be any engaging mechanism as would be apparent to one of the ordinary skill in the art.

By a way of a non-limiting example, and as would be apparent to one skilled in the art, the adapter inserts 314 may include circular rings, oval rings, rectangular inserts, square inserts and/or any other shaped inserts.

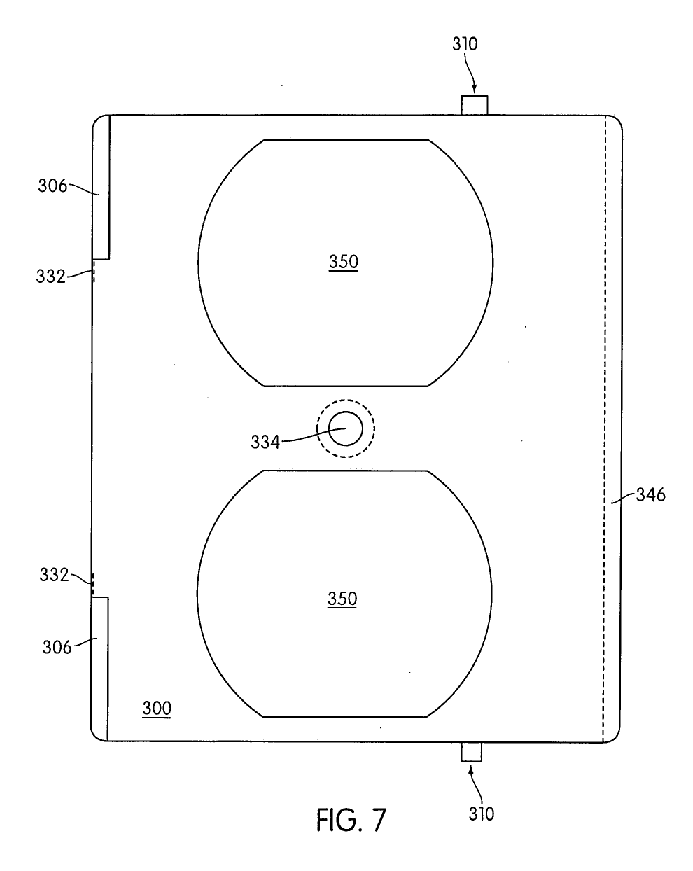

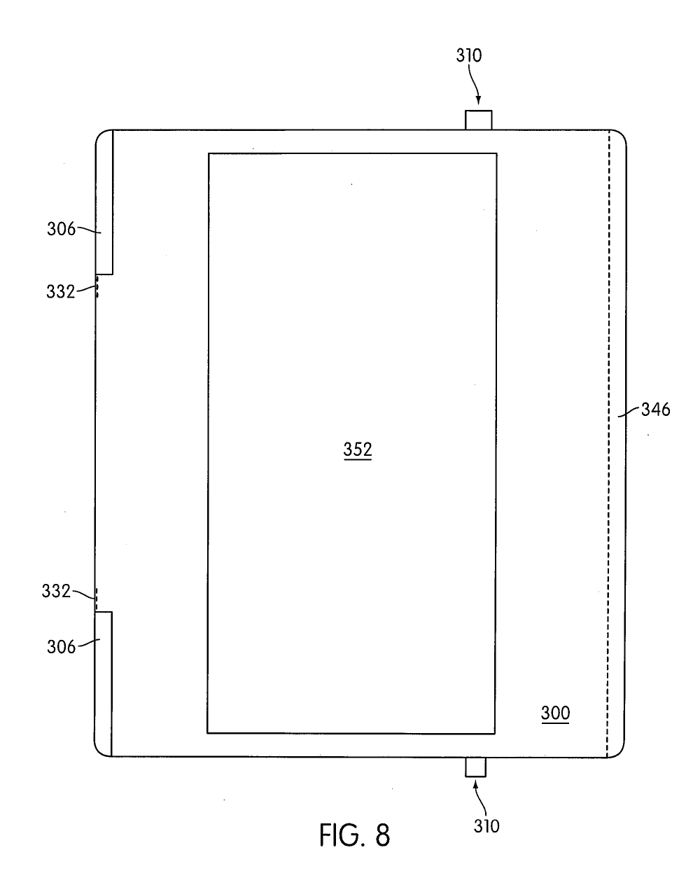

Alternatively, the adapter plate 300 may comprise one or more openings to accommodate a standard electrical receptacle. By way of a non-limiting example, and as would be apparent to one skilled in the art, the adapter plate 300 may be provided with an upper and lower openings 350 that are arranged and adapted to receive the portions or receptacles of a standard duplex electrical device as shown in FIGS. 7 and 40, or the adapter plate 300 may be provided with a single opening 352 that is arranged and adapted to receive the portions or receptacles of a Ground Fault Circuit Interrupter (GFCI) electrical device as shown in FIG. 8.

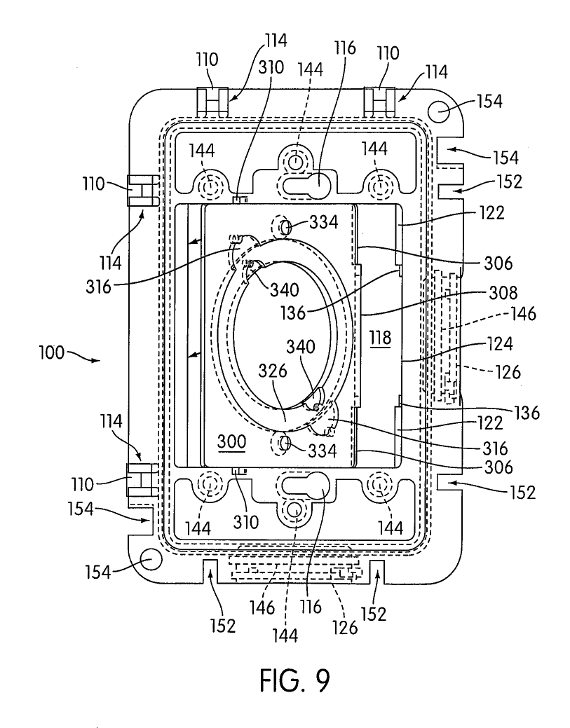

FIG. 9 illustrates a rear view of base 100. Holes 144 that are used for inserting bolts or screws to attach base 100 to a surface are visible. Plate 300 is shown partially rotated in opening 118.

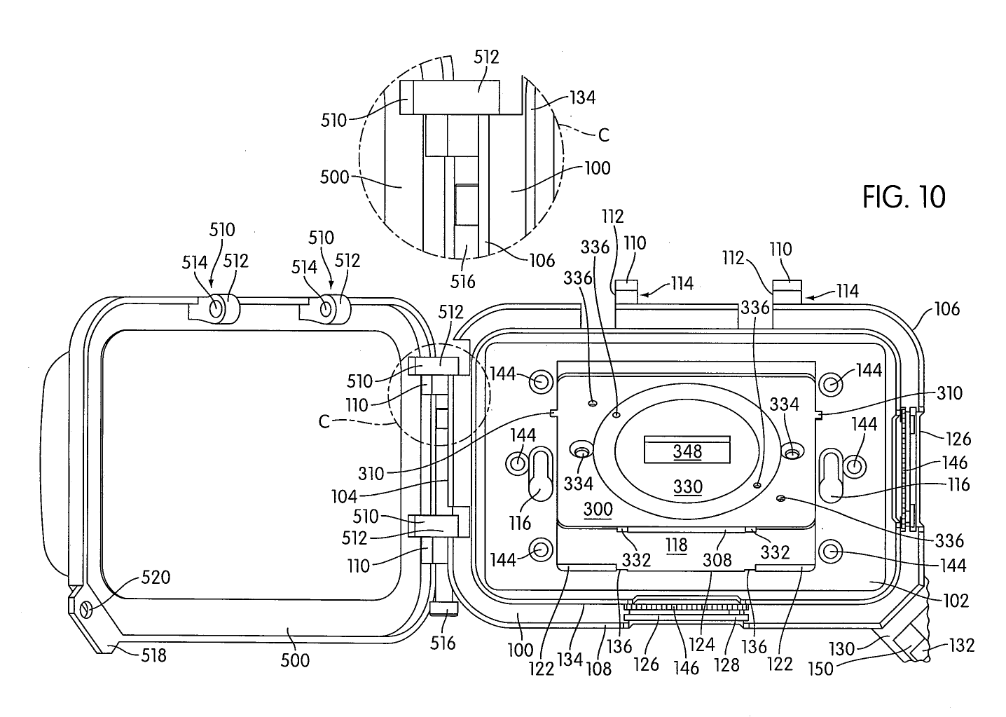

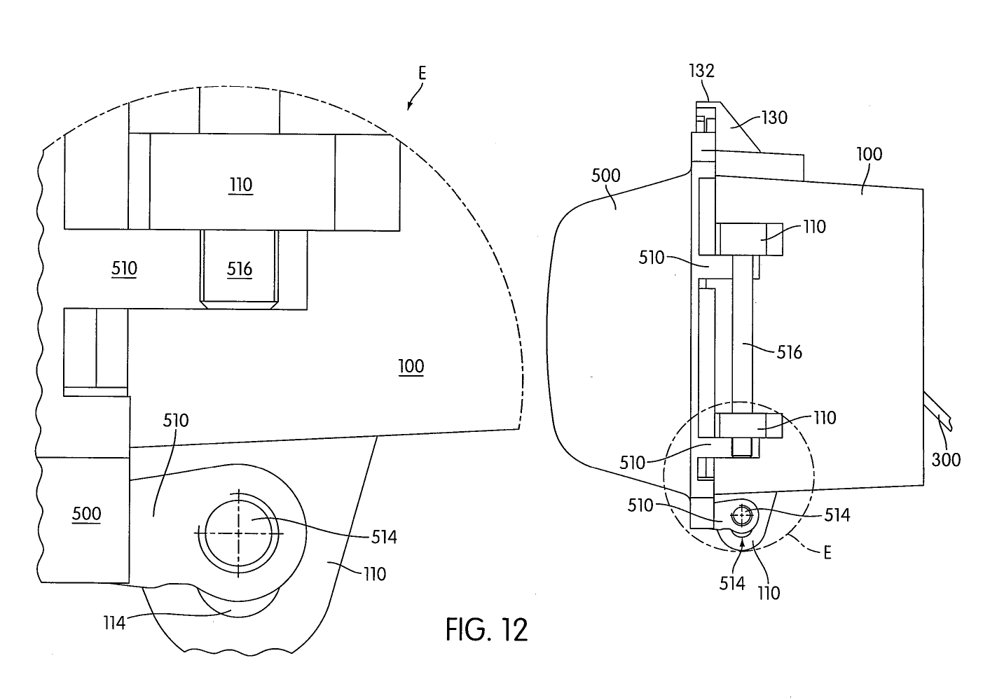

Referring to FIGS. 10-12, the weatherproof cover 500 can be secured to the base 100 and can be configured for covering the base 100, the adapter plate 300 and at least one electrical device so as to provide protection from the environment. The cover 500 has a front wall 502, a top wall 504, a bottom wall 506 and a pair of side walls 508 and 508. The cover 500 has a pair of hinge members 510 located on the top wall 504 and a pair of hinge members 510 located on the side wall 508. The hinge members 510 and 510 comprise raised members 512 and 512 respectively. The raised members 512 and 512 are provided with bolt-receiving openings 514 and 514 respectively.

A removable bolt 516 hingeably connects the cover 500 to the base 100. To mount the cover 500 in a vertical position, the cover 500 is connected to the base 100 by positioning the cover top wall 504 in the same plane as the top wall 104 of the base 100. With this orientation of the base 100 and the cover 500, the bolt 516 can be slid through the bolt-receiving openings 514 and 114 located in the ears 512 and 112 on the cover top wall 504 and base top wall 104, thus connecting the cover 500 to the base 100.

To change the cover 500 from a vertical mounting position to a horizontal mounting position, the bolt 516 is removed from the bolt-receiving openings 514 and 114 located in the ears 512 and 112 on the cover top wall 504 and base top wall 104. The cover 500 can be connected to the base 100 by positioning the cover side wall 508 in the same plane as the base side wall 108. With this orientation of the base 100 and the cover 500, the bolt can be slid through the bolt-receiving openings 514 and 114 located in the ears 512 and 112 on the cover side wall 508 and the base side wall 508, thus connecting the cover 500 and the base 100 in a horizontal mounting position. Therefore, without the need for additional tooling, the user can change the cover 500 from a vertical mounting position to a horizontal mounting position or a horizontal mounting position to a vertical mounting position.

The ears 112 and 512 of the hinge members 110 and 510 are laterally aligned and are located on either side of the center of the cover top wall 504 and the base top wall 104 respectively. The ears 112 and 512 of the hinge members 110 and 510 are laterally aligned and are located on either side of the center of the cover side wall 508 and the base side wall 108 respectively. As would be apparent to one of ordinary skill in the art, the ears can be located any where along the side walls and the top walls of the cover and the base.

The bolt-receiving openings 514 and 514 located on the cover have threads located in the ear to mate with the threads located on the bolt 516. Alternatively, the bolt 516 may be secured by using a nut to connect the cover 500 and the base 100. The cover 500 and the base 100 may be connected to each other by any fastening mechanism that would be apparent to one of the ordinary skill in the art.

A latch plate 518 can be formed at the corner of the bottom wall 506 of the cover 500. The latch plate 518 can be configured to engage with the u-shaped member 132 located on latch tab 130 of the base bottom wall 106. After the cover 500 is connected to the base 100 by means of the bolt 516, the latch plate 518 engages with latch tab 130 to secure the cover 500 with the base 100. To open the cover 500, the latching tab 130 is released. Latch plate 518 includes a hole 520 for receiving a lock. Hole 520 aligns with hole 148 so that a lock can extend through both holes 148 and 520 to secure cover 500 to base 100.

The bolt 516 may be screwed to the cover 500, so that the bolt 516 and the cover 500 form a single assembly. For example, when the user wants to open the cover 500 he or she pushes the cover 500 in an upward direction. Since the cover 500 and the bolt 516 are in a single assembly, the bolt 516 is also pushed along with the cover through the elliptical openings of the base 100. While cover 500 is attached to base 100 with bolt 516, the use of bolt 516 is merely exemplary. Cotter pins may be used as an alternative means to bolt 516 to secure cover 500 to base 100. Bolt 516 may have a threaded end which is received by a threaded hole 514 or 114 to secure bolt to the combined cover 500 and base 100 assembly. Alternatively, cover 500 and base 100 may be formed of plastic and be pivotally joined together with conventional pivotal “snap fit” joints well known to artisans skilled in the art.

Rubber flaps 134 are secured along the periphery of the cover 500 to prevent environmental contamination such as insect or debris accumulation, dust or dirt or rain water accumulation, or any other criteria as would be apparent to one of ordinary skill in the art.

By way of a non-limiting example, and as would be apparent to one skilled in the art, the bolts and the cover may be formed from any impact resistant material such as metal or a weather-proof plastic material. The ribs 310 may have any shape that would be apparent to one of the ordinary skill in the art. The notches 120 are shaped to form a path to receive the ribs along two axes. This path will allow the ribs 310 to lock with the notches 120 and securely connect the adapter plate 300 with the base 100. The path may be L-shaped having a vertical surface and a horizontal surface, curved or any other shape as would be apparent to one of the ordinary skill in the art.

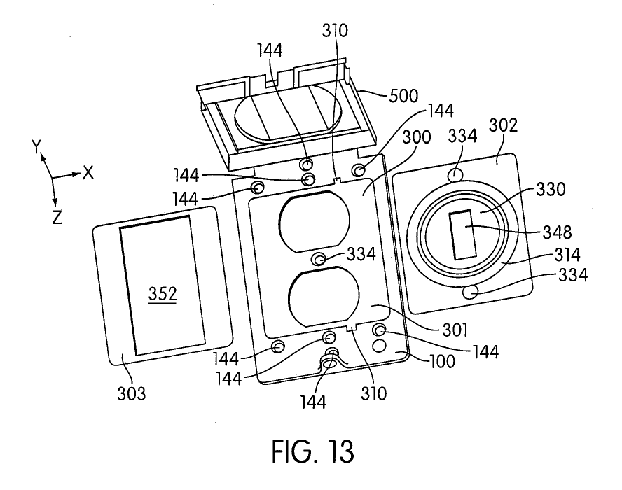

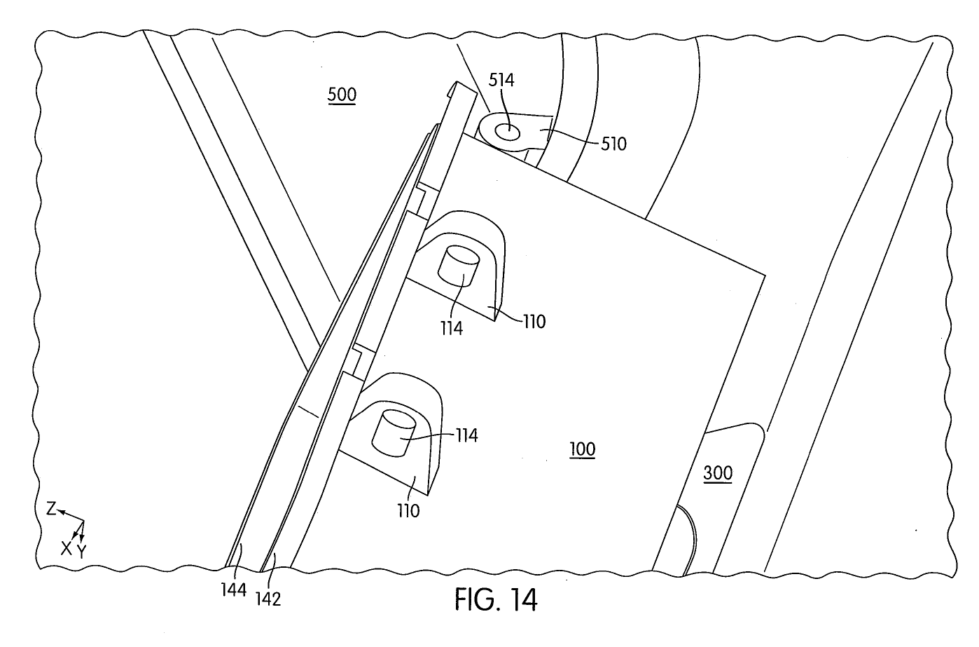

Referring to FIG. 13, in one aspect of the invention the adapter plate 300 is inserted into the base 100 from the side. The base 100 has a slot located horizontally on the side walls 108 and 108 that allows the adapter plate 300 to slide through the slot and be fitted in the opening of the base 100. FIG. 13 shows a duplex adapter plate 301, an adapter plate 302 along with adapter inserts or a GFCI adapter plate 303 that can be placed into the opening 118 of the base 100 using the side entry slots.

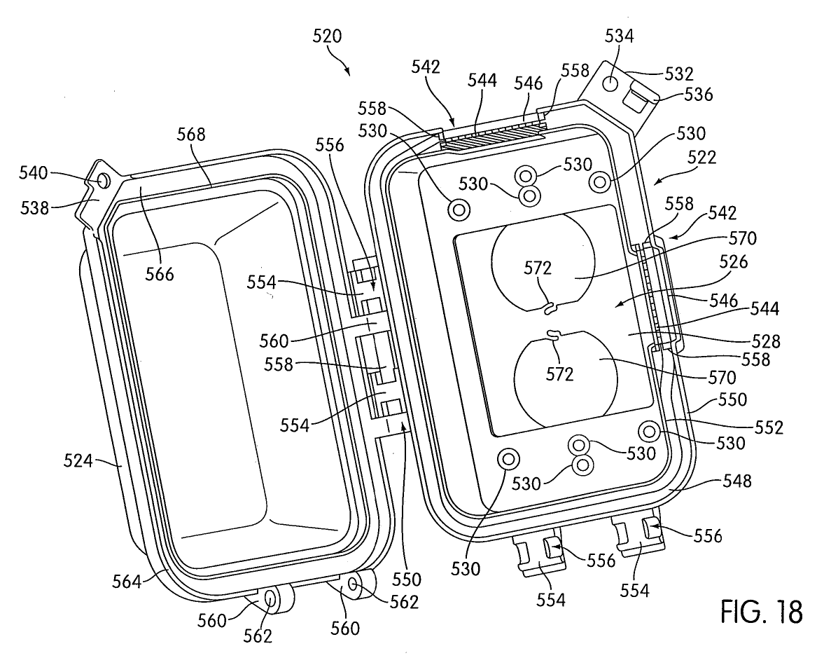

FIG. 18 illustrates a perspective view of a modular electrical assembly 520 having a base 522 and a cover 524 with an adapter plate 528 fitted in a centrally located opening 526 in the base 522. Base 522 is provided with a plurality of tapered holes 530 to receive the contoured head of a threaded screw or bolt that would secure base 522 to a surface. A locking plate 532 protrudes from base 522. Locking protrusion 532 includes a hole 534 and a brace 536. Locking plate 534 is configured to mate with cover locking plate 538 having a hole 540. Holes 534 and 540 are configured to align when cover 524 is closed with base 522. When holes 534 and 540 are aligned when cover 524 is closed, a lock and extend through holes 534 and 540 and lock cover 524 to base 522.

Base 522 is provided with two electrical cable openings 542. Electrical cable openings 542 are provided to allow an electrical cable or cord to extend between the interior and exterior of assembly 520. Electrical cable openings 542 are provided with a plurality of flexible members 544 which easily deform under the force of an electrical cable or cord. Flexible members 544 may be formed from a sheet of rubber or other flexible material. An electrical cord will bend several of flexible members 554 while the remaining flexible members 544 remain in place providing a partial environmental barrier between the interior of assembly 520 and the exterior of assembly 520. A removable cover 546 slides within grooves 558 formed within base 522. When it is desired to extend an electrical cable through one of electrical cable openings 542, removable cover 546 is removed allowing the electrical cable to deform flexible members 544. In the event that it is not desired to extend a cable through one or both of electrical cable openings 542, removable covers 546 are provided to form an environmental barrier for base 522.

A channel 548 is formed along the upper edge of base 522. Channel 548 is bordered by walls 550 and 552. Hinge portions 554 extend from two sides of base 522. Hinges portions 554 are provided with holes 556 to receive a rod 558. Cover 524 includes hinge portions 560 having holes 562. When cover 524 is closed over base 522, hinge portions 560 abut hinge portions 554 and holes 562 align with holes 556 so that rod 558 may extend through both holes 554 and 562, thereby forming a hinge. Hinges portions 554 and 560 are provided on two sides of assembly 520 to enable a hinge to be formed on either side depending upon how it is desirable to open cover 524 on assembly 520.

Cover 524 is provided with walls 564 and 568 that form a channel 566. Walls 564 and 568 mesh with walls 550 and 552 formed in base 522 when cover 524 is closed on base 522. The meshing of walls 564 and 568 with walls 550 and 552 forms an improved environmental barrier or dam protecting the interior of assembly 520 from outside elements such as water or dust. The combination of walls 564, 568, 550 and 552 forces water around the space between cover 524 and base 522, thereby keeping the water from entering assembly 520.

In addition, note that cover 524 is longer and wider than base 522 so as to completely cover the base within the interior of cover 524, thereby protecting the interior of assembly 520 from external water.

Openings 570 are formed in adapter plate 528 to engage a duplex electrical device. Adapter plate 528 is provided spring tongue interlocking mechanism 572. Note that spring tongue interlocking mechanism 572 includes a spring tongue and a curved portion formed in insert 590 that mates with the spring tongue so that the spring tongue does not exert a force on the insert 590. Thus, the spring tongue mechanism is configured to exert a clamping force on an electrical socket extending through the opening 598, and not another insert. Spring tongue interlocking mechanism 572 is made of a resilient material and is configured to engage the electrical device configured to extend through openings 570 and hold it in position with respect to adapter plate 528. Spring tongue interlocking mechanism 572 includes a resilient tongue that is integrally formed with adapter plate 528 and has a rounded end. The resilient tongue is a cantilevered member integral with the adapter plate 528 or adapter insert 615 (shown in FIGS. 34-36). When an electrical device is inserted into openings 570, the resilient tongues of spring tongue interlocking mechanism 572 deform and provide a clamping force to secure adapter insert 528 to the electrical device.

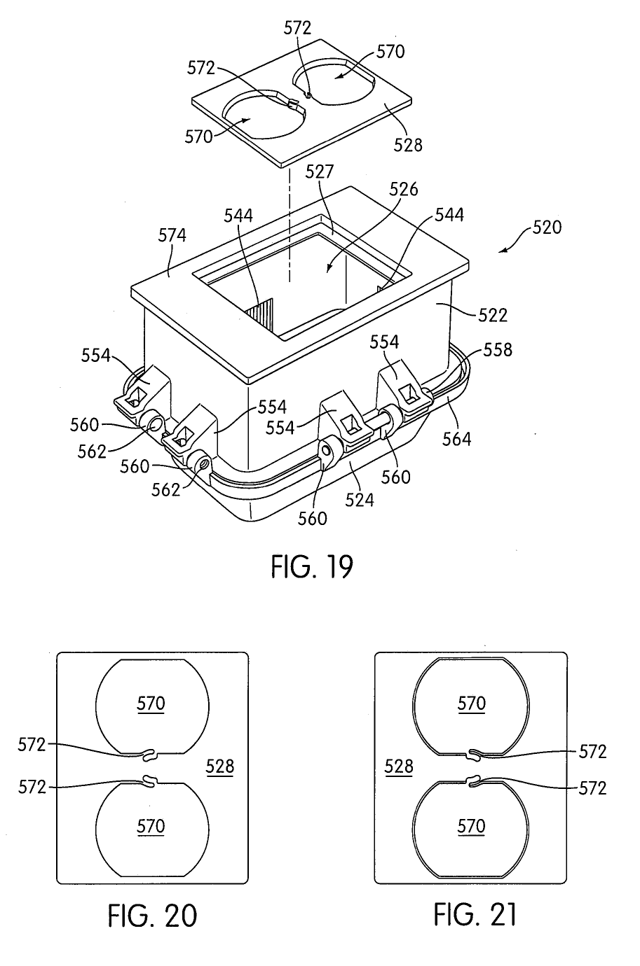

FIG. 19 illustrates a bottom view of a base 522 having a cover 524 and a centrally located opening 526 with an adapter plate 528 having two openings 570 for a duplex electrical device 624. Base 522 is provided with flexible backing material 574 in order to form an environmentally secure seal between assembly 520 and the surface to which assembly 520 is attached. Base 522 is provided with a drain groove 527 to prevent water external to assembly 520 from entering assembly 520. Groove 527 is provided to direct water away from the interior of assembly 520.

In this figure, cover 524 is closed over base 522. Adapter plate 528 is shown removed from opening 526 formed in base 522. Adapter plate 528 fits within groove 527 formed in base 522.

FIG. 20 illustrates a rear view of an adapter plate 528 having two openings 570 for a duplex electrical device 634, wherein the adapter plate 528 has a spring tongue interlocking mechanism 572.

FIG. 21 illustrates a front view of an adapter plate 528 having two openings 570 for a duplex electrical device 634, wherein the adapter plate 528 has a spring tongue interlocking mechanism 572.

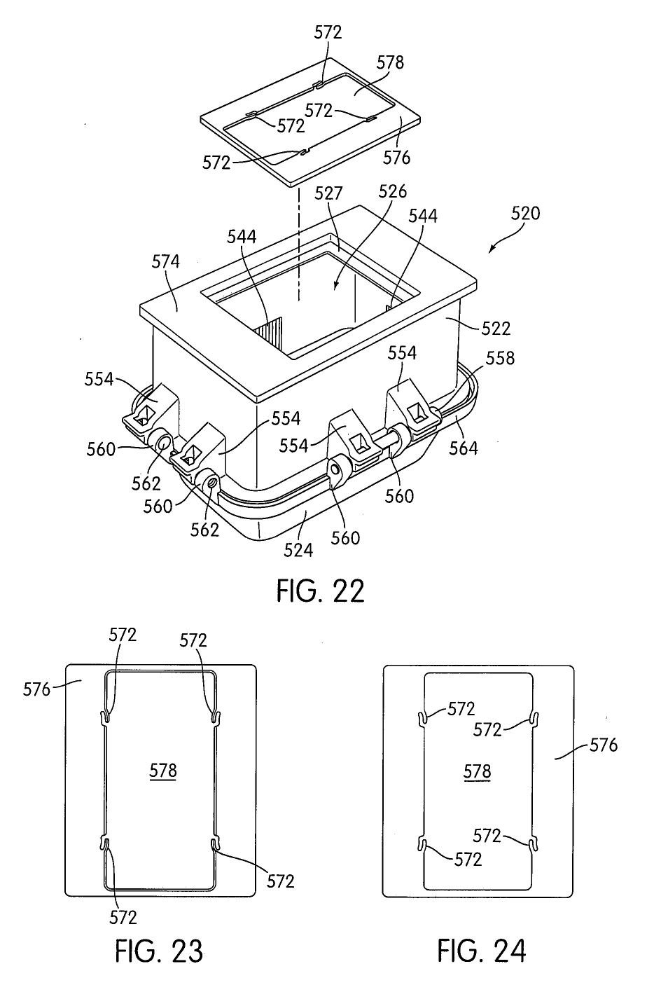

FIG. 22 illustrates a bottom view of a base 522 having a cover 524 and a centrally located opening 526 with an adapter plate 576 having a rectangular opening 578 for a GFCI electrical device. Adapter plate 576 is provided with spring tongue interlocking mechanism 572 to secure adapter plate 576 to the GFCI electrical device. Adapter plate 576 fits within groove 527 formed in base 522.

FIG. 23 illustrates a rear view of an adapter plate 576 having an opening 578 for a GFCI electrical device, wherein the adapter plate 576 has a spring tongue interlocking mechanism 572.

FIG. 24 illustrates a front view of an adapter plate 576 having an opening 578 for a GFCI electrical device, wherein the adapter plate 576 has a spring tongue interlocking mechanism 572 to secure adapter plate 576 to the GFCI electrical device.

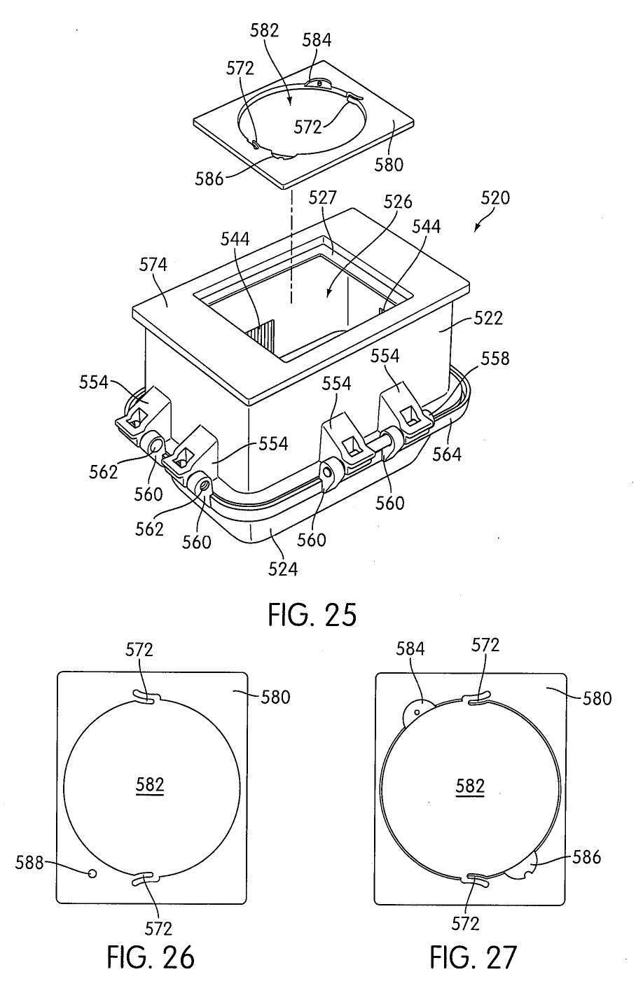

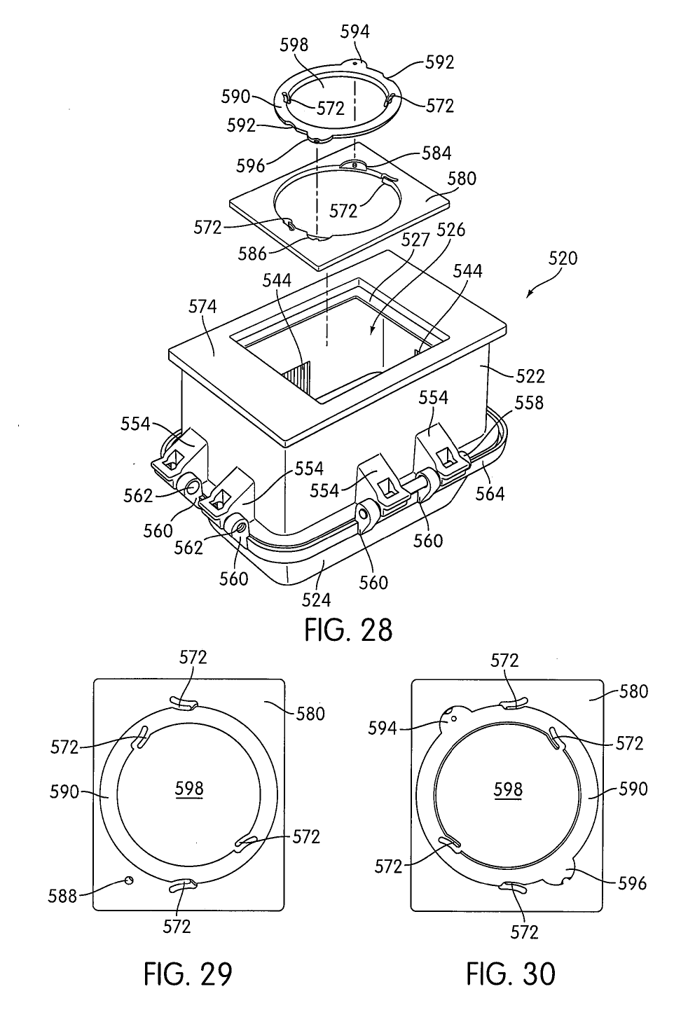

FIG. 25 illustrates a bottom view of a base 522 having a cover 524 and a centrally located opening 526 with an adapter plate 580 having a circular opening 582 for an electrical device. Adapter plate 580 includes shaped notches 584 and 586 to receive an outer adapter insert 590 or 600 (shown in FIGS. 28-33). Spring tongue interlocking mechanisms 572 are provided to secure adapter plate 580 to an electrical device or to adapter inserts 590 or 600. Adapter plate 580 fits within groove 527 formed in base 522.

FIG. 26 illustrates a rear view of an adapter plate 580 having a circular opening 580 for an electrical device, wherein the adapter plate 580 has a pair of spring tongue interlocking mechanisms 572. A hole 588 is provided to access the electrical device through adapter plate 580.

FIG. 27 illustrates a front view of an adapter plate 580 having a circular opening 582 for an electrical device, wherein the adapter plate 580 has a pair of spring tongue interlocking mechanisms 572. Adapter plate 580 includes shaped notches 584 and 586 to receive an outer adapter insert 590 or 600 (shown in FIGS. 28-33).

FIG. 28 illustrates a bottom view of a base 522 having a cover 524 and a centrally located opening 526 with an adapter plate 580 having a circular opening 582 for an electrical device and an adapter insert 590 configured to fit within the adapter plate 580. Adapter insert 590 is provided with a pair of curved notches 592 that mate with the pair of spring tongue interlocking mechanisms 572 formed in adapter plate 580, thereby clamping adapter insert 590 to adapter plate 580. Protrusions 594 and 596 mate with shaped notches 584 and 586 formed in adapter plate 580. Opening 598 is provided to engage the socket of an electrical device. A pair of spring tongue interlocking mechanisms 572 is provided in adapter insert 590 to clamp adapter insert 590 to the electrical device.

FIG. 29 illustrates a rear view of an adapter plate 580 having a circular opening 598 for an electrical device and an adapter insert 590 configured to fit within the adapter plate 580, wherein both the adapter plate 580 and adapter insert 590 have pairs of spring tongue interlocking mechanisms 572 for clamping to each other and an electrical device.

FIG. 30 illustrates a front view of an adapter plate 580 having a circular opening 598 for an electrical device and an adapter insert 590 configured to fit within the adapter plate 580, wherein both the adapter plate 580 and adapter insert 590 have pairs of spring tongue interlocking mechanisms 572. Protrusions 594 and 596 formed in adapter insert 590 mate with shaped notches 584 and 586 formed in adapter plate 580.

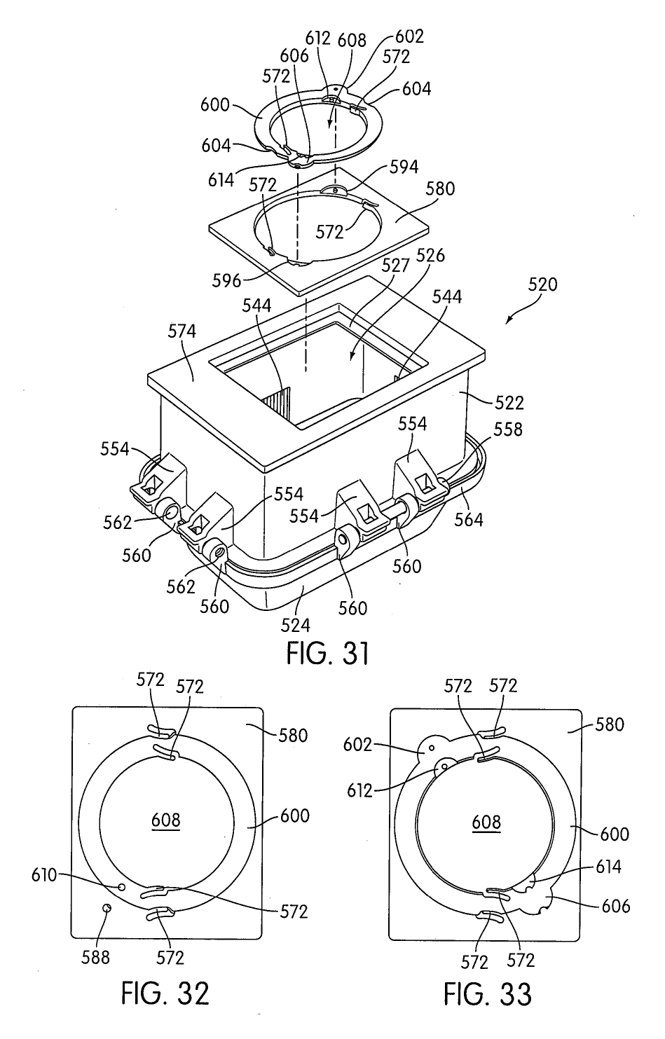

FIG. 31 illustrates a bottom view of a base 522 having a cover 524 and a centrally located opening 526 with an adapter plate 580 having a circular opening 612 for an electrical device and an adapter insert 600 configured to fit within the adapter plate 580. Adapter insert 600 is provided with protrusions 602 and 606 to mate with shaped notches 594 and 596 formed in adapter plate 580. Contoured surfaces 604 are formed in adapter insert 600 to mate with the pair of spring tongue interlocking mechanisms 572 formed in adapter plate 580, thereby clamping adapter insert 600 to adapter plate 580. Adapter insert 600 is provided with a pair of spring tongue interlocking mechanisms 572 to clamp adapter insert 600 to an electrical device. Adapter insert 600 is provided with shaped notches 612 and 614 to receive protrusions 616 and formed in inner adapter insert 615 (shown in FIGS. 31-33).

FIG. 32 illustrates a rear view of an adapter plate 580 having a circular opening 608 for an electrical device and an adapter insert 600 configured to fit within the adapter plate 580, wherein both the adapter plate 580 and adapter insert 600 have pairs of spring tongue interlocking mechanisms 572 to clamp the adapter plate to the adapter insert and the adapter insert to an electrical device.

FIG. 33 illustrates a front view of an adapter plate 580 having a circular opening 608 for an electrical device and an adapter insert 600 configured to fit within the adapter plate 580, wherein both the adapter plate 580 and adapter insert 600 have pairs of spring tongue interlocking mechanisms 572. Protrusions 602 and 606 formed in adapter insert 600 mate with shaped notches 594 and 596 formed in adapter plate 580. Adapter insert 600 is provided with shaped notches 612 and 614 to mate with protrusions 616 and 620 formed in inner adapter insert 615 (shown in FIGS. 34-36).

FIG. 34 illustrates a bottom view of a base 522 having a cover 524 and a centrally located opening 526 with an adapter plate 580 having a circular opening 622 for an electrical device and an outer adapter insert 600 configured to fit within the adapter plate 580 and a inner adapter insert 615 configured to fit within the outer adapter insert 600. Adapter insert 600 is provided with shaped notches 612 and 614 to mate with protrusions 616 and 620 formed in inner adapter insert 615. Contoured surfaces 618 formed in inner adapter insert 615 mate with the pair of spring tongue interlocking mechanisms 572 formed in outer adapter insert 600. Inner adapter insert 615 is also provided with a pair of spring tongue interlocking mechanisms 572 to clamp an electrical device to inner adapter insert 615.

FIG. 35 illustrates a rear view of an adapter plate 580 having a circular opening 622 for an electrical device and an outer adapter insert 600 configured to fit within the adapter plate 580 and a inner adapter insert 615 configured to fit within the outer adapter insert 600, wherein the adapter plate 580, outer adapter insert 600, and inner adapter insert 615 all have pairs of spring tongue interlocking mechanisms 572 for clamping.

FIG. 36 illustrates a front view of an adapter plate 580 having a circular opening 622 for an electrical device and an outer adapter insert 600 configured to fit within the adapter plate 580 and a inner adapter insert 615 configured to fit within the outer adapter insert 600, wherein the adapter plate 580, outer adapter insert 600, and inner adapter insert 615 all have spring tongue interlocking mechanisms 572. Protrusions 602 and 606 formed in outer adapter insert 600 mate with shaped notches 594 and 596 formed in adapter plate 580. Protrusions 616 and 620 formed in inner adapter insert 615 mate with shaped notches 612 and 614 formed in outer adapter insert 600. A pair of spring tongue interlocking mechanisms 572 extend from inner adapter insert 615 to engage and clamp an electrical device.

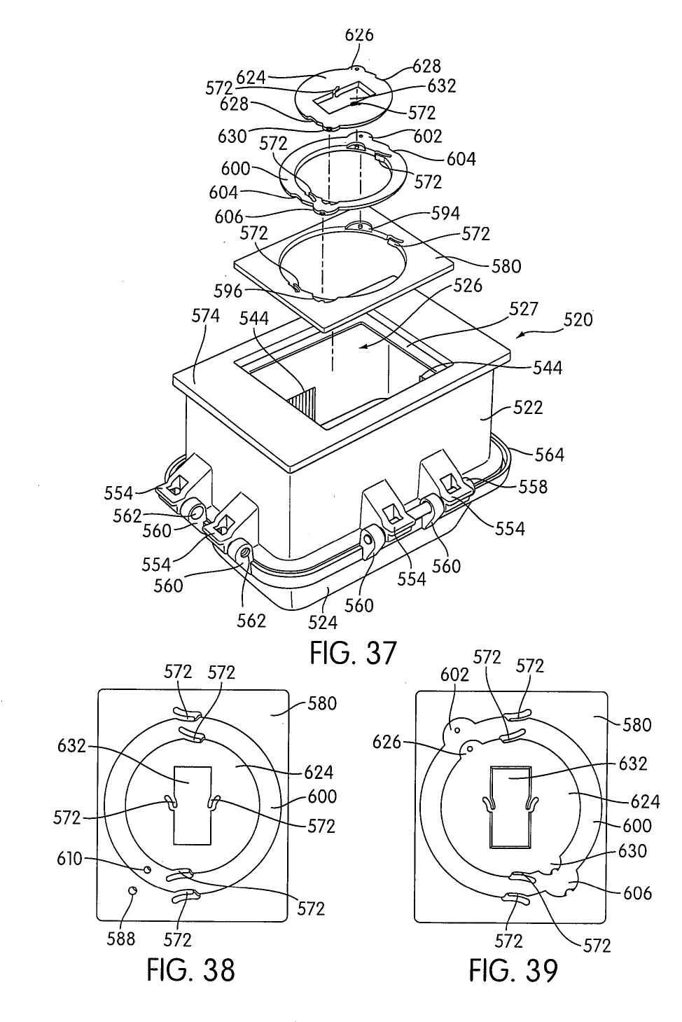

FIG. 37 illustrates a bottom view of a base 522 having a cover 524 and a centrally located opening 632 with an adapter plate 580 having a circular opening 582 and an outer adapter insert 600 configured to fit within the adapter plate 580 and a inner adapter insert 624 configured to fit within the outer adapter insert 600. Inner adapter insert 624 is provided with protrusions 626 and 630 that mate with shaped notches 612 and 614 formed in outer adapter insert 600. Contoured surfaces 628 formed in inner adapter insert 624 mate with spring tongue interlocking mechanisms 572 formed in outer adapter insert 600. A pair of spring tongue interlocking mechanisms 572 extend from inner adapter insert 624 to clamp an electrical device.

FIG. 38 illustrates a rear view of an adapter plate 580 having a circular opening 582 and an outer adapter insert 600 configured to fit within the adapter plate 580 and a inner adapter 624 insert configured to fit within the outer adapter insert 600, wherein the adapter plate 580, outer adapter insert 600, and inner adapter insert 624 all have a spring tongue interlocking mechanism 572 for clamping.

FIG. 39 illustrates a front view of an adapter plate 580 having a circular opening 582 and an outer adapter insert 600 configured to fit within the adapter plate 580 and a inner adapter insert 624 configured to fit within the outer adapter insert 600, wherein the adapter plate 580, outer adapter insert 600, and inner adapter insert 624 all have a spring tongue interlocking mechanisms 572 for clamping.

FIG. 40 illustrates an adapter plate 528 having two openings 570 for a duplex electrical device 634 prior to insertion on the duplex electrical device 634, wherein the adapter plate has a spring tongue interlocking mechanism 572. Duplex electrical device 634 has a pair of electrical outlets 636, each of which mates with openings 570 formed in adapter plate 528.

FIG. 41 illustrates an adapter plate 528 having two openings 570 to mate with the outlets 636 of an duplex electrical device 634, wherein the adapter plate 528 has a spring tongue interlocking mechanism 572. Spring tongue interlocking mechanism 572 clamps with outlets 636. Spring tongue interlocking mechanism 572, being made of a resilient material, bend under the force of contact with outlets 636, thereby exerting a clamping force against outlets 636 and holding adapter plate 528 to duplex electrical device 634.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in the light of the above disclosure. The scope of the invention is to be defined only by the claims appended hereto, and by their equivalents.

What is claimed is:

1. An electrical assembly comprising:
a base configured for accepting at least one electrical device, the base having a rear wall, a top wall, a bottom wall, a pair of opposing side walls and an opening located in the rear wall;
an adapter plate configured to:
(i) fit in the opening of the base;
(ii) accept and clamp on to the at least one electrical device; and
(iii) accept one or more adapter inserts placeable in an opening of the adapter plate without clamping onto the adapter inserts and wherein the adapter insert, upon assembly, allows the adapter plate to accommodate and clamp onto the at least one electrical device.

2. The assembly of claim 1 further comprising a cover, wherein the cover is secured to the base and is configured for covering the base, the adapter plate and the at least one electrical device, the cover having a front wall, a top wall, a bottom wall and a pair of opposing side walls.

3. The assembly of claim 1, wherein the adapter inserts securely connect the adapter inserts with each other and with the adapter plate.

4. The assembly of claim 1, wherein the adapter plate comprises one or more resilient members that are constructed and arranged to secure the adapter plate with the electrical device.

5. The assembly of claim 1, wherein the adapter insert comprises one or more resilient members that are constructed and arranged to secure the adapter insert with the electrical device.

6. The assembly of claim 1, wherein the adapter inserts comprises one or more resilient members and one or more recesses, wherein the recesses on an outer periphery of an inner adapter insert are constructed and arranged to receive the resilient members on an inner periphery of an outer adapter insert, to connect the adapter inserts to each other.

7. The assembly of claim 4, wherein the electrical device comprises a switch, an outlet, a receptacle, a ground fault circuit interrupter, a dimmer, and/or other electrical device.

8. The assembly of claim 6, wherein the adapter insert further comprises one or more first engaging members and one or more second engaging members; each first engaging member having a recess located therein and each second engaging member having a protrusion that mates with the recess in the first engaging member.

9. The assembly of claim 8, wherein the first engaging members are located on the outer periphery of the adapter insert and the second engaging members are located on the inner periphery of the adapter insert.

10. The assembly of claim 9, wherein the first engaging member on the outer periphery of an inner adapter insert interlocks with the second engaging member on an inner periphery of an outer adapter insert, to connect the adapter inserts to each other.

11. The assembly of claim 9, wherein the first engaging member on the outer periphery of the outer adapter insert interlocks with a second engaging member on an inner periphery of the adapter plate, to connect the outer adapter insert with the adapter plate.

12. The assembly of claim 2, wherein the shape of the adapter inserts is selected from the group consisting of circular rings, oval rings, rectangular inserts and square inserts.

13. The assembly of claim 2, wherein the base further comprises slots located on the side walls and the bottom walls of the base to insert a drain plate.

14. The assembly of claim 13, wherein the drain plate is removable and is interchangeable between the slots located on the side walls and the bottom walls of the base.

15. The assembly of claim 13, wherein the drain plate is interchanged between the slot on the bottom wall of the base and the slot on the side wall of the base when the cover is changed from a vertical mounting position to a horizontal mounting position or when the cover is changed from a horizontal mounting position to a vertical mounting position.

16. The assembly of claim 1, comprising rubber flaps secured along the periphery of the base or the cover to protect the assembly from environmental contamination.

17. The assembly of claim 1, comprising one or more drain holes located on the bottom wall of the base or the cover to drain water, when the drain plate fails to prevent water or moisture from entering the enclosure.

18. An assembly comprising
(i) a base having a rear wall that includes an opening, a top wall, a bottom wall and a pair of opposing side walls;
(ii) a cover pivotally secured to the base and is configured for covering the base so as to provide protection from the environment, and the cover having a front wall, a top wall, a bottom wall and a pair of opposing side walls; and
(iii) an adapter plate configured to be positioned within the opening formed in the base, wherein the adapter plate includes an opening configured to receive and clamp onto an electrical device.

19. The assembly of claim 1, wherein a latch tab located on the base engages with a latch plate on the cover so as to secure the cover to the base together.

20. The assembly of claim 1, further comprising an inner water dam and an outer water dam located on along the periphery of the base to collect water so as to prevent water from entering the electrical device.

21. The assembly of claim 1, wherein the adapter plate comprises a spring tongue interlocking mechanism configured to provide a clamping force on an object configured to mate with the adapter plate.

22. The assembly of claim 1, wherein the adapter insert comprises a spring tongue interlocking mechanism configured to provide a clamping force on an object configured to mate with the adapter insert.

23. The assembly of claim 1, wherein the adapter plate comprises a cantilevered member integral with the adapter plate configured to provide a clamping force on an object configured to mate with the adapter plate.

24. The assembly of claim 1, wherein the adapter insert comprises a cantilevered member integral with the adapter insert configured to provide a clamping force on an object configured to mate with the adapter insert.

25. The assembly of claim 24, wherein the adapter insert further comprises a contoured surface configured to mate with the cantilevered member integral with the adapter plate.

26. The assembly of claim 1, wherein the base is provided with an opening on at least one of the opposing side walls, wherein the base further comprises a plurality of flexible members directly abutting each other, the plurality of flexible members filling the entire space formed by said opening.

27. The assembly of claim 26, wherein the adapter plate comprises a spring tongue interlocking mechanism configured to provide a clamping force on an object configured to mate with the adapter plate.

28. The assembly of claim 27, further comprising an adapter insert configured to attach to the adapter plate, the adapter insert comprising a spring tongue interlocking mechanism configured to provide a clamping force on an object configured to mate with the adapter insert.

29. The assembly of claim 18, wherein the adapter plate comprises a cantilevered member integral with the adapter plate configured to provide a clamping force on an object configured to mate with the adapter plate.

30. The assembly of claim 29, further comprising an adapter insert configured to attach to the adapter plate, wherein the adapter insert comprises a cantilevered member integral with the adapter insert configured to provide a clamping force on an object configured to mate with the adapter insert.

31. The assembly of claim 30, wherein the adapter insert further comprises a contoured surface configured to mate with the cantilevered member integral with the adapter plate.

32. The assembly of claim 18, wherein the base is provided with an opening on at least one of the opposing side walls, wherein the base further comprises a plurality of flexible members directly abutting each other, the plurality of flexible members filling the entire space formed by said opening.
